(19) United States
(12) Patent Application Publication
(10) Pub. No.: US 2003/0090482 A1
(43) Pub. Date: May 15, 2003

(54) 2D to 3D stereo plug-ins

(76) Inventors: Armand M. Rousso, New York, NY (US); Jeffrey K. Fergason, Menlo Park, CA (US); Lawrence J. Simpson, Fremont, CA (US); Vincent E. Robinson, San Jose, CA (US)

Correspondence Address: Warren A. Sklar, Renner, Otto, Boisselle & Sklar, LLP, 19th Floor, 1621 Euclid Avenue, Cleveland, OH, 44115-2191, US

(21) Appl. No.: 10/255,925

(22) Filed: Sep. 25, 2002

Related U.S. Application Data
(60) Provisional application No. 60/325,007, filed on Sep. 25, 2001.

(51) Int. Cl. G06T 15/00

(52) U.S. Cl. 345/419

(57) ABSTRACT

The present invention provides software, sometimes referred to as plug-ins, that may be used with existing graphics software, for example, digital imaging software, to create 3D stereoscopic capabilities in the existing software. Using the plug-ins is possible to make a full featured graphics software which previously was confined to present and to create 2D images, now be able to present and to create 3D stereo images. A method for enhancing the capability of existing graphics software to function with 3D stereoscopic capability is included.

### CROSS REFERENCE TO RELATED APPLICATIONS

This patent application claims priority to United States Provisional Patent Application entitled “2D TO 3D STEREO PLUG-INS” filed Sep. 25, 2001 and assigned Serial No. 60/325,007 of which is incorporated herein by reference.

### FIELD OF INVENTION

The present invention relates generally, as indicated, to 2D to 3D stereo plug-ins and, more particularly, to such plug-ins as used in combination with existing graphics software, an example of which may be that sold under the trademark Adobe Photoshop and/or others in the Adobe Photoshop tools and software. More particularly, the graphics software is digital imaging software; and according to various embodiments described below, such graphics software may be construed as graphics software generally and, more particularly, to digital imaging software. Additionally, the invention relates to a method of converting 2D graphic images to 3D stereoscopic images using such plug-ins in combination with existing or commercially available graphics software.

Reference to existing or commercially available graphics software means software that can be used to develop, to make, to modify, to view, etc., images. Those images may be displayed, printed, transmitted, projected or otherwise used in various modes as is well know. For example, the Adobe Photoshop software can be used for many purposes, as is well known. Reference to graphics software as being existing or commercially available is intended to mean not only at present but also that which has been existing or commercially available in the past and that which may exist or become commercially available in the future. For brevity, all of these are referred to below collectively and severally as “existing” graphics software.

Many existing graphics software have the ability to work in two dimensions (referred to herein sometimes as 2D or 2-D), but digital imaging packages are not able conveniently or not at all able to develop images in three dimensions (referred to herein sometimes as 3D or 3-D). Existing digital imaging software is not able to take a 2D image and to create from it a 3D image. Reference herein to 3D image, stereoscopic image and 3D stereoscopic image are intended to mean the same or substantially the same.

Moreover, many existing graphics software do not have the ability to develop and to display respective left eye image and right eye image in such manner that the images appear as being viewed from two different points of view, e.g., from the left and eye and the right eye of a person looking at an image, scene, etc.

Much information can be gleaned by viewing an image in three dimensions compared to the information available when the image is viewed in two dimensions. Depth information may allow a better understanding of the image. Depth information may provide for a more interesting image and also may be used for other purposes, too, one example is geographical information systems (height information, pictures of mountainous regions), gastroenterology or for bone spur viewing and/or other medical purposes. Depth information may be used for other purposes, too. Numerical data analysis interpretation can be enhanced using 3D images.

Various techniques have been used in the past to view images in three dimensions, i.e., to provide a stereoscopic view of a stereoscopic image. One old technique is referred to as anaglyph in which one image e.g., a left eye image, is such that it will transmit through a red filter, and the other image, e.g., the right eye image, transmits through a blue filter (other colors can be used, too). The two images may be stored in a common frame or in separate frames, but are seen only through the respective color filters that discriminate between colors. Another technique has been to discriminate between the left and right eye images by displaying them or projecting them onto a screen such that the left eye image and the right eye image are displayed sequentially; and respective left eye and right eye shutter lenses are operated in sequence with the images so that the left eye image is seen by the left eye while the shutter over the right eye is closed; and vice-versa. Another approach is to display the images sequentially on a monitor or display, for example, or otherwise, and to polarize, e.g. circularly or plane polarize the light from the monitor, display, etc., so that the light representing a left eye image has one polarization and the light representing the right eye image is polarized differently; and corresponding analyzers “polarizers” before respective eyes of a person discriminate between the respective left and right eye images. Other techniques may also be used to display and to view 3D or stereoscopic images and/or to store image data for display. Also, other types of displays, projectors, monitors, etc. and equivalent devices may be used to provide an image for viewing, projection, etc. and be used with the present invention.

Data representing images can be stored electronically. The data may be used to operate a monitor, display, projector, etc. to present an image for viewing. Such data may be stored in various formats as is well known in the art.

Data representing a 3D stereoscopic image may be stored in a number of different formats and may be decoded or used to provide respective left eye and right eye images, for example. As an example, the data necessary to represent a 3D stereoscopic image of a scene actually may be two different images, one being the image as seen from the left eye of viewer and one from the right eye; sometimes such images are obtained using two different cameras that are viewing the scene from two different points of view, e.g., the points of view of the left eye and the right eye of the person. Sometimes the two different images are obtained by adjusting or offsetting one image relative to a second image, which is a copy of the first, but slightly modified to provide an offset so that there is an apparent 3D stereoscopic view provided when seen through the two respective eyes of a person. The amount of offset used to obtain such two images may be determined by analysis of depth information from the original two dimensional image. That analysis may include a consideration of gray scale data that represents depth or distance from the front of the image to the back of the image. For example, data near the front (foreground) may be white and data near the back (background) black, and that which is between front and back, e.g., mid-scene, may be various shades of gray. Since gray scale may be represented, for example, in an Adobe Photoshop type of graphics software and presentation obtained from it in an eight bit data word, up to 256 shades of gray from white through black may be represented by a single 8 bit word.

Various formats have been used to store image data representing respective left eye and right eye images (an image pair) for representing a 3D stereoscopic image. Several examples include those referred to as interlaced (sometimes referred to as interleaved), over and under, side by side, and anaglyph. These formats are well known. As was mentioned above, anaglyph uses red and blue colors, for example. In the interlaced format, the left eye image may be represented by the odd lines of a data storage frame, e.g., that used to store video data or data for a liquid crystal display or some other display, projector, etc., and the right eye image by the even lines or vice versa. During display of such data, the data contained in the odd lines may be shown on a display, monitor or the like to present one eye image and subsequently, the data represented by the even lines may be shown to present the other eye image. By switching between the odd and even lines being displayed on the display or monitor, the sequence of left eye and right images, for example, can be shown. The left and right eye images may be stored in the left side and right side portions of a data frame (side-by-side format) or in the top portion and bottom portion of a data frame (over-under format); and such data may be decoded and used to drive or operate a display, monitor, or the like to obtain sequential images for viewing.

The approach taken in the past to prepare, construct draw, and/or to present 3D stereoscopic images for viewing has been to write fairly complex computer software to develop the images, to modify images, to allow artists or others to create the images, etc., and to display the images. The time, effort and money to prepare such software packages is substantial. To minimize time and cost, sometimes it has been practice to provide those packages without the substantial sophistication, capabilities, functions, etc., of existing graphics software, such as Adobe Photoshop graphics software, that are designed primarily to provide images in two dimensions.

Accordingly, there is a need to improve the ability to develop, create, etc., 3D stereoscopic images and to be able to display them to obtain high quality, high level of creativity, to enable tools that are familiar to the artist and many of the functions that are available in existing full function graphics software.

### SUMMARY

With the above in mind, an aspect of the present invention is to provide software, sometimes referred to as plug-ins, that may be used with existing graphics software to create 3D stereoscopic images.

With the above in mind, an aspect of the present invention is to provide software, sometimes referred to as plug-ins, that may be used with existing digital imaging software to create 3D stereoscopic images.

Another aspect is to use two dimensional image data from an existing graphics software and to modify that image data to obtain 3D stereoscopic image data.

Another aspect is to use two dimensional image data from an existing digital imaging and to modify that image data to obtain 3D stereoscopic image data.

Another aspect is to make a full featured graphics software which previously was confined to present and to create 2D images, now be able to present and to create 3D stereo images.

Another aspect is to make a full featured graphics software which previously was confined to present and to create 2D images, now be able to present and to create 3D stereo images, and allows the user to employ conventional tools with which the user is familiar without having to learn a new software package.

These and other objects, features and advantages of the present invention will become apparent from the following description when read in connection with the accompanying drawings.

One or more of the above and other aspects, objects, features and advantages of the present invention are accomplished using the invention described and claimed below. It will be appreciated that although features of the invention may be described in connection with a given embodiment or aspect of the invention, such features may be used with other embodiments; thus, one or more features that are disclosed may be used in various combinations or alone, all of which will be evident from the description herein.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed.

Although the invention is shown and described with respect to certain embodiments, it is understood that equivalents and modifications will occur to others skilled in the art upon the reading and understanding of the specification. The present invention includes all such equivalents and modifications, and is limited only by the scope of the claims.

### BRIEF DESCRIPTION OF THE DRAWINGS

In the annexed drawings:

### DESCRIPTION

Referring in detail to the drawings, wherein like reference numerals refer to like parts, and initially to FIG. 1, a graphics system 10 according to the invention is illustrated. The graphics system 10 includes an existing graphics software 11, e.g., Adobe Photoshop (others may be used, but for brevity reference will be made to Photoshop software below). The graphics system 10 also includes 2D to 3D plug-ins 12 of the present invention that have features and functions that convert 2D image data from 3D image data. The plug-ins 12 also include features and functions to format the 3D image data in various formats, e.g., interlaced, side-by-side, over-under, and/or anaglyph. Such conversions may be conventional; the plug-ins 12 allow for interfacing with the Photoshop software 11 to make it appear as though such Photoshop software has the native capability to effect such conversion. A 2D (sometimes referred to as “planar”) image data input 13 is provided the system 10. The system 10 is able to convert the 2D image data to 3D stereoscopic image data, e.g., as respective stereo image pairs 14 that can be used to create displayed, projected, etc., images for viewing by a person, for example. Alternatively, the system 10 may be used to create the 2D image, e.g., using the Photoshop software 11 without the need for a separate input 13; still further, if desired, the system 10 may include the ability to convert 3D stereoscopic images to 2D (planar) images.

The invention takes advantage of open architecture of Photoshop software 11, particularly, Photoshop digital imaging software, that allows the accessing of channel, layers, grayscale, and other image information. That information is obtained in the plug-ins 12 and the plug-ins or the plug-ins in combination with such digital imaging software can provide for the creating of 3D images from a 2D image, can create 2D images from a 3D image. As the plug-ins 12 are software that can easily be used and interactive with the digital image software, the tools typically available in the digital imaging software can be used to create, modify, etc., images without the user having to learn a new set of tools, functions, etc. This feature substantially increases the value of the digital imaging software and the value and convenience of use thereof by users.

Referring to FIG. 2, a procedure 20 for creating a stereo image pair using the system 10 of FIG. 1 is shown. Using existing Photoshop software tools shapes and areas that are to be used, created, modified, etc., in the final image are defined at 21. At 22 the shape and area definitions are saved to respective levels or channels. Levels or layers and channels are conventional terms, definitions, features, data and operations typical of Photoshop software. At 23 the levels are arranged and grayscale values are assigned in the respective levels or layers. Respective layers may be used to store respective left and right image data of stereo image pairs. Based on those grayscale values offsets between respective stereo image pairs can be determined so that when the stereo image pair is viewed sequentially by the left and right eyes of a person, a 3D stereoscopic image is seen, as is represented at the virtual view that is created at 24.

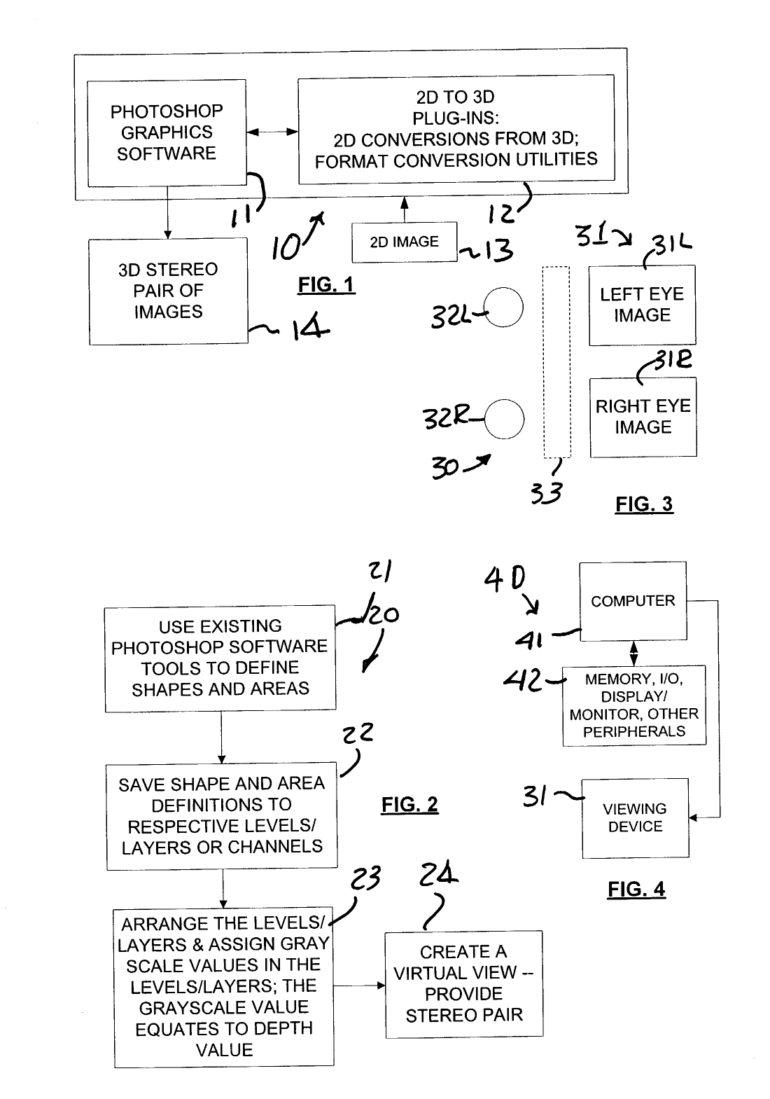

Briefly turning to FIG. 3, a 3D stereoscopic image viewing system 30 is illustrated schematically. A viewing device 31 is shown including two displays 31L, 31R are shown. These displays may be any device that is able to display, project, etc. images for viewing. The images are obtained from the system 10, for example, to operate the displays directly or may be provided via a video signal device, computer, or some other device operative to drive the displays. The images are to be viewed by the left and right eyes 32L, 32R of a person, for example. A discriminator 33 is shown in FIG. 3. The discriminator 33 may be respective light shutters that are placed before respective eyes 32L, 32R to allow the left eye to see a left eye image from the display 31L and the right eye to see the right eye image from the display 31R. Alternatively, the discriminator 33 may be a polarization switching device and the viewing device 31 may be a single display that sequentially displays left and right images, which are provided at different respective polarizations, e.g., left and right circular polarization, orthogonal plane polarization, etc., and respective passive polarizers (analyzers) may be included as a part of the discriminator, being placed before the eyes 32L, 32R to discriminate between the left and right images, which are synchronized with the polarization switching device. An exemplary polarization switching device is that known as surface mode liquid crystal cell, PI cell, or the like. Other types of image viewing systems may be used equivalently, including autostereoscopic displays or others, to the image viewing system 30 to provide 3D stereo image pairs for viewing.

In FIG. 4 is a schematic illustration of an exemplary computer system 40 for carrying out the various methods and steps described herein using the graphics system 10, for example. The exemplary computer system 40 includes a computer 41; memory, input/output devices (e.g., keyboard, mouse, joy stick, etc.), display or monitor, and/or other peripheral devices, all collectively referred to below and represented at 42. The various portions of the computer 41 and the peripheral devices 42 may be in a single unit, may be separate components, may be connected by wire, by network, by the Internet, by radio or optical connections, etc. The computer 41 and peripheral devices 42 cooperate to operate or to use the graphics system 10 to prepare and to obtain images for the image viewing system 30 for viewing by a person, for example.

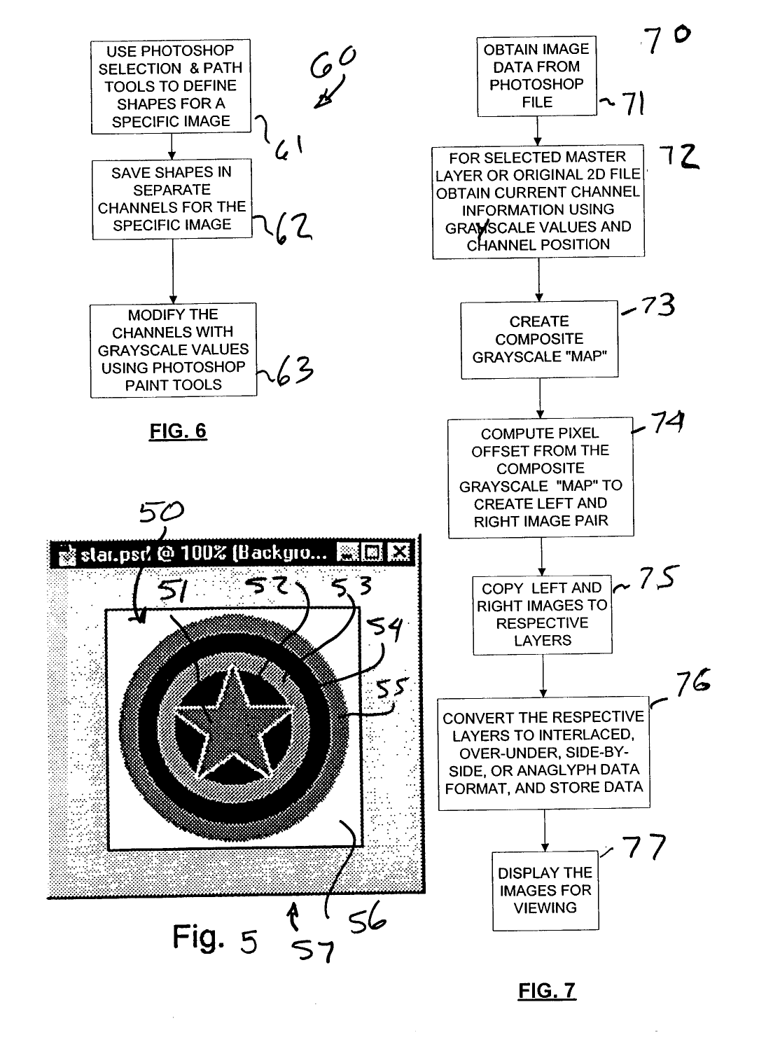

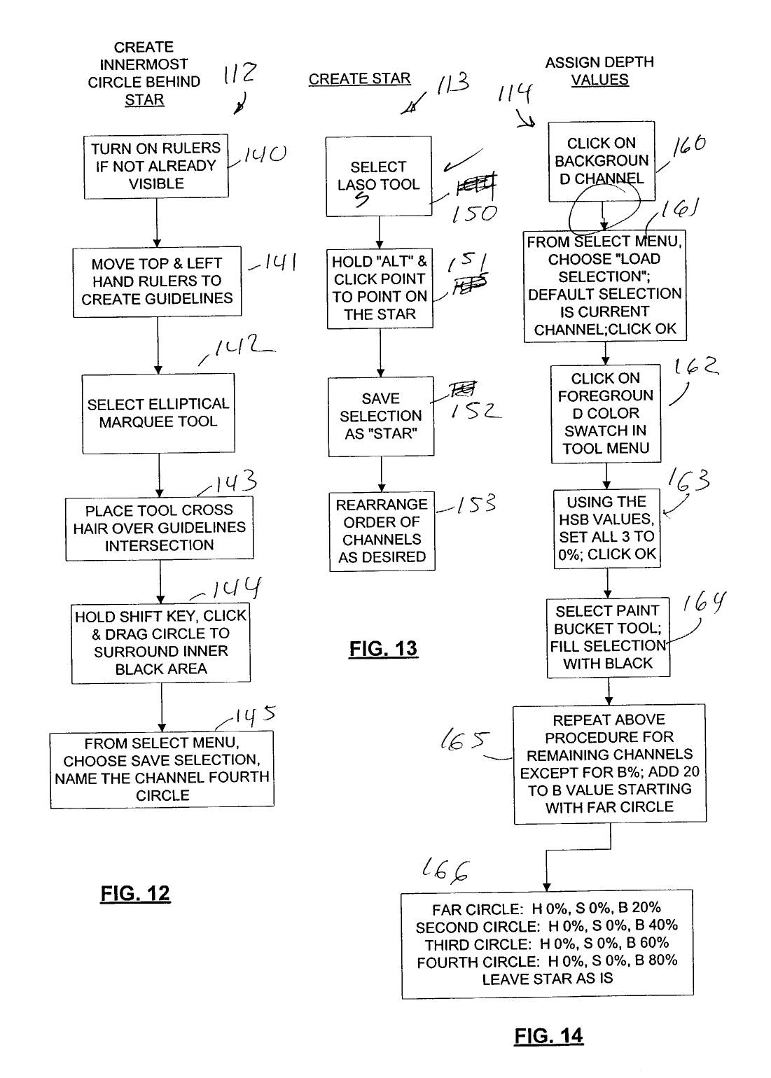

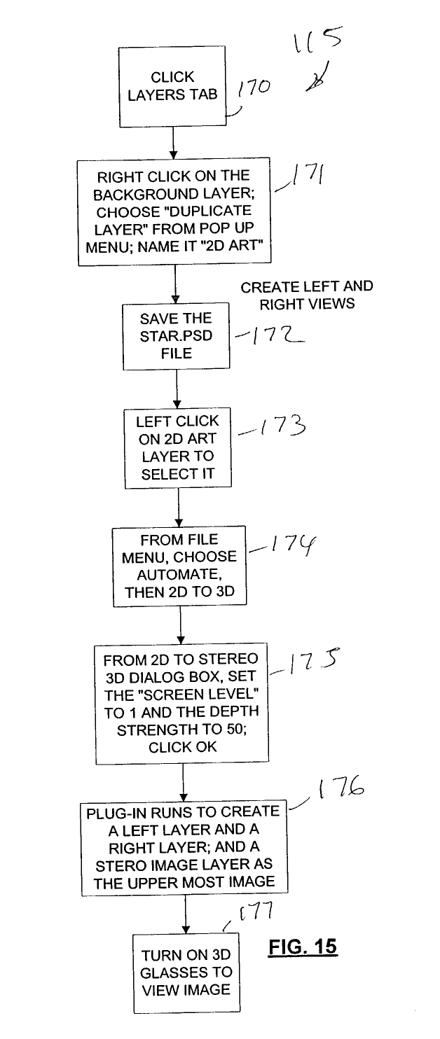

In FIG. 5 is an exemplary illustration of an image 50 of a star 51 on a black background 52 and surrounded by three rings 53, 54, 55. The star, background and rings are within a white rectangle 56. The entire image is shown as part of a monitor displayed image 57 of an exemplary monitor, such as one of the displays 31 mentioned above. The image 50 has 3D characteristics, as will be described below, and the method for creating the 3D image 50 also will be described below, particularly with respect to FIGS. 11-15 using the system 10 with the plug-ins 12 and existing graphics software, e.g., Photoshop software 11. Suffice it to say here that the several rings, the background, and the star, or some or all of them may be in the same or in different levels to provide a planar (2D) image or a 3D stereoscopic image.

Turning to FIG. 6, a method 60 to create the image 50 is illustrated. In the method 60, at 61 Photoshop software selection and path tools are used to define shapes for the image 50. Exemplary shapes are the rectangle, the star, the circular background, and the three rings. The shapes are saved at 62 in separate channels for the specific image 50. At 63 the channels are modified with grayscale values using the Photoshop software paint tools. Those modifications of grayscale values allow for the determination of “depth” or relative spaced-apart relation of the respective portions 51-56 of the image 50.

In FIG. 7 is illustrated a summary 70 of the steps used to create an image for viewing using the method, software and system of the present invention. At 71 image data is obtained from a Photoshop software file, e.g., 2D image data 13 (FIG. 1), created by the Photoshop software 11, provided from another source or graphics software package, etc. At 72, for a selected master layer or an original 2D file, the current channel information is obtained using grayscale values and channel position. As was mentioned before, channel and layer are terms defined in the Photoshop software. At 73 a composite grayscale map is created. The composite grayscale map represents grayscale characteristics of different parts of a channel or of a layer, or of several of them as a composite of the image and is used to compute pixel offsets for the stereo image pairs that are to be obtained. The grayscale map can be obtained in a number of ways. One example is to add the grayscale values at the same relative physical location in the “plane” or image of each of several layers to obtain a sum of those values, to do the same over the area of the layers, and, thus to obtain a composite of the grayscale of those locations as though superimposed. Other techniques also may be used to obtain the composite grayscale map. At 74 pixel offset is computed from the composite grayscale “map” to create left and right image pair. Computation can be based on a variety of factors. Examples, may be the extent of variation in grayscale values over the image, e.g., if the values range from 0 (white, closest foreground) to black (furthest background). If the range of grayscale values is only a small portion of the 0 to 256 range, then there likely would be little offset; and the offset may increase as the range increases. Consideration also may be given to the locations at which variations in grayscale values occur, e.g., is there a large variation between closely adjacent locations in the composite layer or a small variation. Based on the computed pixel offset the left and right image pair (sometimes referred to herein as stereo image pair) are created.

At 75 the left and right images are copied to respective layers. For example, one layer (the term is defined in the Photoshop software 11) may contain the image data for the left image of the image pair; and a second layer may contain the image data for the right image of the image pair. At 76 the respective layers are converted to desired format for storage and use; the data is stored in long term storage medium, e.g., magnetic drive or tape, optical disk, DVD, CD, etc. The exemplary formats are interlaced, over-under, side-by-side, or anaglyph; other formats also may be used, if desired. At 77 the images are displayed, e.g, as is described above and illustrated in FIGS. 3 and 4.

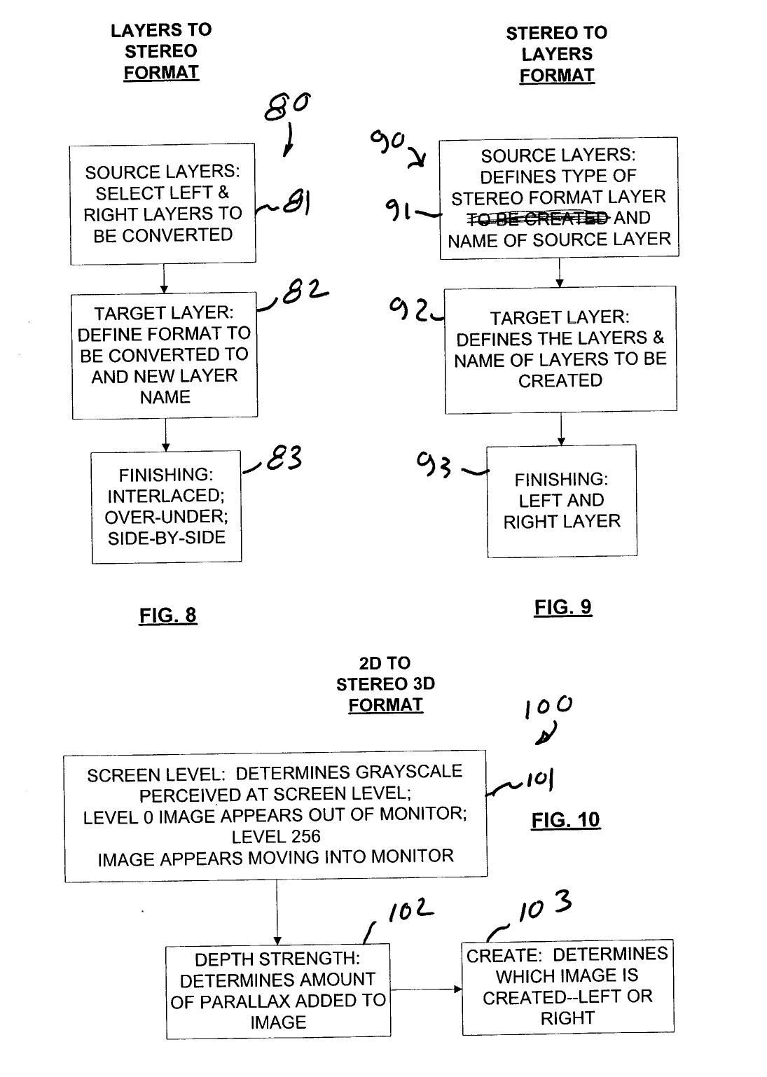

Briefly referring to FIG. 8, a summary procedure for converting layers to stereo format is shown at 80. At 81 source layers are determined by selecting left and right layers to be converted to the stereo format. At 82 a target layer is determined by defining the format to be converted to and the new name of the layer. At 83 the data is finished by putting it into interlaced, over-under or side-by-side format or in anaglyph format or some other format.

Briefly referring to FIG. 9, a summary procedure for converting stereo to layers format is shown at 90. The layers may be two respective 2D images. At 91 source layers are determined by defining the type of stereo format (e.g., over-under, etc.) layer to be created and the name of the source layer. At 93 the data is finished by obtaining left and right images.

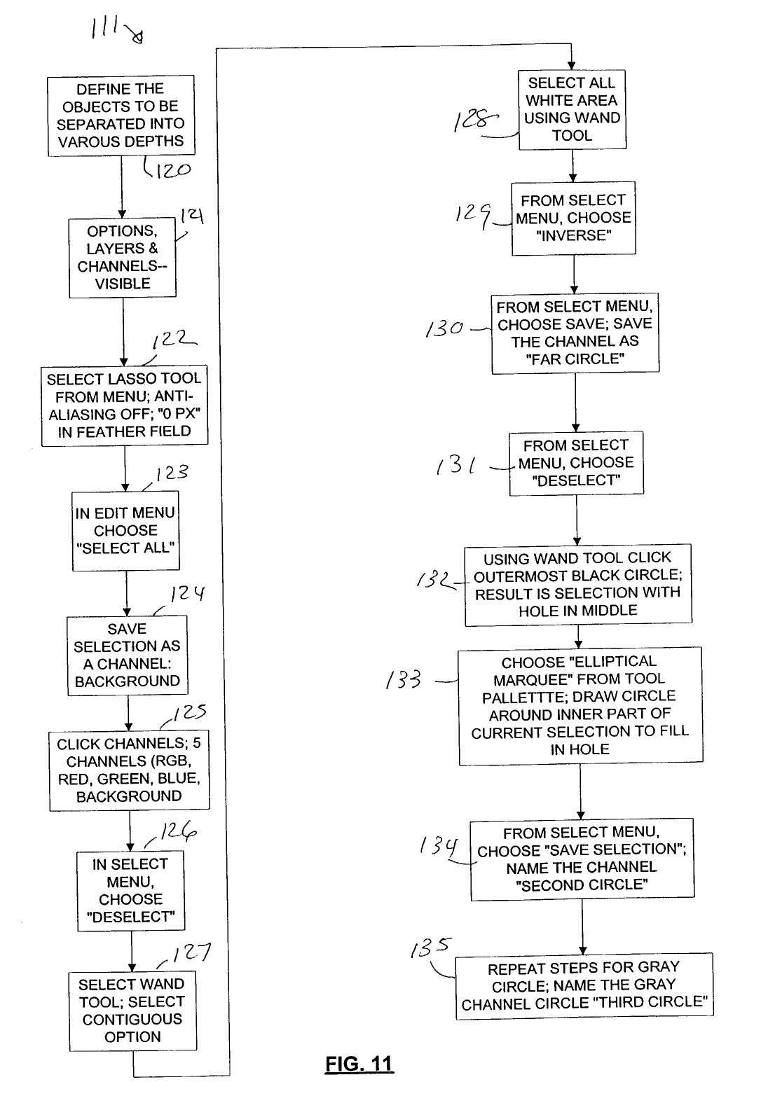

FIG. 10 shows a conversion of 2D to 3D format at 100. At 101 screen level information is used. The screen level determines grayscale perceived at screen level. As was mentioned above, a grayscale level of 0 indicates the image appears out of the monitor and a grayscale level of 256 indicates the image appears moving into the monitor or in the monitor, e.g., behind the surface of the monitor screen. Other conventions also may be used. For example, a level 128 may represent an image at the screen of the monitor and levels 0 and 256 out and in the monitor. Level 256 may represent an image at the screen and level 0 an image out of the monitor, etc. Usually a higher grayscale level or value represents an image farther away from the viewer and a lower grayscale level or value represents an image relatively closer to the viewer. At 102 the depth strength is determined which determines the amount of parallax added to the image. Depth strength may be determined by the range of grayscale values, e.g., the larger the range, the greater the depth strength, and the smaller the range, the weaker the depth strength. Manual or other offsets or other considerations may be used, too, to alter depth strengths, if desired, e.g., as was described above. At 103 a determination of which image is created, the left or right one. The other image may be created based on depth strength.

An example of “pseudocode” that may be used to carry out the various functions described above and in the example below is, as follows:

ScreenLevel - Depth to be perceived as at the level of the screen.
DepthStrength - The amount of stereo strength (offset) to use. This is
determined as a ratio relative to the ScreenLevel and an arbitrary offset
scalar.
CurrentDepth - The current grayscale value being evaluated.
View - Current Image/View being generated.
Do

Determine View

If Right View

If CurrentDepth Is Greater Than ScreenLevel

Offset by DepthStrength to the Left

Else If CurrentDepth Is Less Than ScreenLevel

Offset by DepthStrength to the Right

Else

Do Not Move

End If

End If
If Left View

If CurrentDepth Is Greater Than ScreenLevel

Offset by DepthStrength to the Right

Else If CurrentDepth Is Less Than ScreenLevel

Offset by DepthStrength to the Left

Else

Do Not Move

End If

End If

Fill in holes caused by the stereo offset by stretching
pixels determined to be behind image with a Bicubic Filter

Repeat Until Full Image Processed

An example of the invention used to create the image 50 of FIG. 5 is described below with reference to flow charts 111-115 of FIGS. 11-15.

After starting your Photoshop 6.0 software, open the star.psd file in the tutorial directory on the CD.

The first step 120 in converting an image into 3D is to define the objects that will be separated into various depths. To make object selection easier, “options”, “layers” and “channels” should be visible 121 in the work area. (These displays can be turned on or off from the Photoshop “windows” menu.)

Before we begin, select 122 the lasso tool from the tool menu. Anti-aliasing should be off and there should be a “0 px” in the feather field.

To Start:

1. In the edit menu, choose “Select all” 123.

2. From the “Select” menu choose “Save selection” 124.

Name the channel background.

Click 125 on the “Channels” tab in your work area. There should be 5 channels. RGB, Green, Glue and the background channel you just created (FIG. 3). Now we will create the other 5 objects in our basic image.

1. From the “Select” menu choose “Deselect” 126.

2. Select 127 the wand tool. Match the options displayed in FIG. 4.

3. Place the wand in the outer white area and click the left mouse button 128. All of the outer white area should be selected.

4. From the “Select” menu choose “Inverse” 129. The line of marching ants should now appear around the outer area of the largest circle.

5. From the “Select” menu choose 130 “Save selection”. Name the channel far circle.

You should not have a new channel named far circle under the background channel (FIG. 5).

Let's continue.

1. From the “Select” menu choose “Deselect” 131.

2. With the wand tool selected 132, click in the outer most black circle. You should now have a selection with a hole in the middle.

3. Choose 133 the “elliptical marquee” from the tool pallette. While holding down the Shift key, draw a circle around the inner part of the current selection. This will fill in the hole in the selection so you have one large circular selection.

4. From the “Select” menu choose “Save selection” 134. Name the channel second circle.

Repeat 135 the previous steps for the gray circle and name it third circle.

This next step will be easier with rulers visible. If rulers are not visible you can turn them on from th “View” menu.

To create the selection for the inner most circle behind the star:

1. Click in the top ruler and drag 141a guideline down to the top of the smallest circle. The guideline should be cutting through the top of the star. Repeat using the left hand ruler to create another guideline on the left. (FIG. 6)

2. Select 142 the elliptical marquee tool. Place 143 the cross hair for the tool over the intersection of the two guidelines. While holding down the shift key 144, click and drag a circle so it surrounds the inner black area. It is alright if the new selection cuts off the tips of the star.

3. From the “Select” menu choose 145 “Save selection”. Name the channel fourth circle.

The last object left to be created is the star:

1. Select 150 the lasso tool. While holding down 151 the “alt” key. Click from point to point on the star. When you have a selection you are happy with. Save 152 the selection and name it star.

Rearrange 153 the order of your channels by clicking and dragging them to the appropriate place.

New we are ready to assign depth values to our objects. We will start with the background.

1. Click on the background channel 160.

2. From the select menu choose “Load selection” 161. The default selection will be the current channel you are on. Click O.K.

3. Click on the foreground color swatch 162 in the tool menu. Using 163 the HSB values set all three to 0%. Click OK.

4. Select 164 the Paint Bucket tool and fill the selection with black.

5. Repeat 165 the procedure for the remaining channels with the exception of the B %. Add 20 to the B value starting with the far circle. Values 166 for the various levels are:

Far Circle: H 0%, S 0%, B 20%

Second Circle: H 0%, S 0%, B 40%

Third Circle: H 0%, S 0%, B 60%

Fourth Circle: H 0%, S 0%, B 80%

Leave the star as it is.

Your channels will resemble FIG. 9.

Let's see how it looks in 3D!

Click 170 on the layers tab to return to the layers view. Right 171 Click on the background layer and choose “duplicate layer” from the pop up menu. Name it 2d art (FIG. 10).

Save 172 the star.psd file.

Now, for the left and right views.

1. Left click 173 on the 2d art layer to select it.

2. From the file menu, choose 174 Automate then auto 2d to 3d. The menu in FIG. 11 will pop up. Select OK.

3. When the 2d to stereo 3d dialogue opens, set 175 the “screen level” to 1 and the depth strength to 50. Click OK.

4. When the plug in runs 176, it will create a left and right layer as well as a stereo image layer as the upper most image.

5. Turn on your 3d glasses 177 to view the image on an appropriate display or using the 3D glasses on which images are presented directly to respective eyes.

Summarizing, the plug-ins functions are available after a photoshop user opens or creates a new bitmap file. The end user then uses photoshop's selection and path tools to define various shapes which are saved to separate channels for this specific image. These channels are then modified with grayscale values using Photoshop paint tools. Once these processes are complete the conversion plugins kick in. The plugins communicate with photoshop using the guidelines and rules set forth in the photoshop plugin SDK. For example, in the SDK, it outlines how to get the information contained in a given channel auto223d.8li One plug-in automates and guides the end user through the use of the format functions; this takes two selected layers from the layer manager for a given photo and composites them using an interlaced stereo format. It requires at least two layers be present. Another plug-in combines two layers in the chosen stereo format; side by side, interlaced, anaglyph, etc. lyr2dpth.8li For the selected master layer, or original 2D file, pulls the current channel information using grayscale values and channel position and creates a composite grayscale “map” which is used for the pixel offset calculations by the stereo3D.8bf to create the left and right pair. These in turn are copied to individual layers. sftolayr.8li Takes an existing stereo formatted image and breaks it into to 2D layers. stereo3d.8bf Uses the composite grayscale “map” to calculate the stereo pair. The algorithm is based on pixel offset relative to the grayscale value for a given pixel.

We claim:

1. Plug-in software, comprising software for interacting with a graphics imaging software to create 3D images from 2D images.

2. The Plug-in software of claim 1, further comprising in combination therewith digital imaging software.

3. A method for enabling graphics imaging software to function to provide 3D capability, comprising adding plug-ins to the software.

4. The method of claim 3, said adding comprising adding plug-ins to existing digital imaging software.
